(19) United States
(12) Patent Application Publication
(10) Pub. No.: US 2015/0074272 A1
(43) Pub. Date: Mar. 12, 2015

(54) APPLICATION MANAGEMENT NETWORK DEVICE AND APPLICATION MANAGEMENT METHOD THEREOF

(71) Applicant: Institute For Information Industry, Taipei (TW)

(72) Inventors: Sheng-Kai HUANG, New Taipei City (TW); Shan CHIN, New Taipei City (TW); Feng-Sheng WANG, Tainan City (TW)

(73) Assignee: Institute For Information Industry, Taipei (TW)

(21) Appl. No.: 14/023,720

(22) Filed: Sep. 11, 2013

(51) Int. Cl. H04L 12/24

(52) U.S. Cl. CPC H04L 41/50
USPC 709/225

(57) ABSTRACT

An application management network device and an application management method thereof are provided. The application management network device receives an application request from a VDI user device. The application management network device distributes a license of the application to the VDI user device according to the application request. The application management network device maintains a VDI application connection between the VDI user device and the at least one application server after the VDI user device executes the application deployed on the at least one application server based on the license.

### FIELD

The present invention relates to an application management network device and a application management method thereof; and more particularly, the application management network device and the application management method thereof according to the present invention are used for application management with cloud computing systems.

### BACKGROUND

In conventional application service system (ex., app-stores), users login in the application service system via network and download the applications they paid for. For example, if a user wants to review a PDF document on a mobile device, the user can download a PDF viewing software from the app-store via network after paying for it, and install the PDF viewing software on the mobile device. Therefore, the user can execute the PDF viewing software on the mobile device and review the PDF document via the mobile device. However, there are many defects in the above procedures.

Specifically, the defects of using the conventional application service system are: (a) for software developer, the applications can be plagiarized freely since they are downloadable on the internet; (b) for software developer, the cost of deploying the software to the client's ends is obviously higher; (c) for user or enterprise, the purchased licenses of the software needed to be deployed on the specific devices, which causes the inflexibility of using the software; (d) for user or enterprise, it is too expensive to purchase a complete license of the software if the user or enterprise just needs short-term use of the software.

According to the above descriptions, a new type of providing application service is in an urgent need since there are many defects in the conventional application service system.

### SUMMARY

A primary objective of certain embodiments of the invention is to provide an application management method for use in an application management network device. The application management network device is used in a cloud computing system. The cloud computing system comprises the application management network device and at least one application server. A virtual desktop infrastructure (VDI) user device connects to the cloud computing system via network.

The application management method in certain embodiments comprises: (a) enabling the application management network device to receive an application request from the VDI user device, wherein the application request is used for requesting usage of an application deployed on the at least one application server; (b) enabling the application management network device to distribute a license of the application to the VDI user device according to the application request; (c) enabling the application management to maintain a VDI application connection between the VDI user device and the at least one application server after the VDI user device executes the application deployed on the at least one application server based on the license.

Another objective of certain embodiments of the invention is to provide an application management network device for used in a cloud computing system. The cloud computing system comprises the application management network device and at least one application server. A VDI user device connects to the cloud computing system via network. The application management network device comprises a storage unit, a transceiver and a processing unit.

The storage unit is configured to store a license of an application deployed on the at least one application server. The transceiver is configured to receive an application request from the VDI user device. The application request is used for requesting usage of the application deployed on the at least one application server. The processing unit is configured to distribute the license of the application to the VDI user device according to the application request via the transceiver, and to maintain a VDI application connection between the VDI user device and the at least one application server via the transceiver after the VDI user device executes the application deployed on the at least one application server based on the license.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a network environment of an application management network device according to the first embodiment of the present invention;

FIG. 1B is a block diagram of the application management network device according to the first embodiment of the present invention;

FIG. 2 is a schematic view of another network environment of the application management network device according to the second embodiment of the present invention;

FIG. 3 is a flowchart diagram of a application management method according to the third embodiment of the present invention; and

FIGS. 4A-4B are flowchart diagrams of a application management method according to the fourth embodiment of the present invention.

### DETAILED DESCRIPTION

The present invention may be explained with reference to the following example embodiments thereof. However, these example embodiments are not intended to limit the present invention to any specific examples, embodiments, environments, applications or implementations described in these embodiments. Therefore, description of these example embodiments is only for purpose of illustration rather than to limit the present invention. In the following embodiments and the attached drawings, elements not directly related to the present invention are omitted from depiction; and dimensional relationships among individual elements in the attached drawings are illustrated only for ease of understanding but not to limit the actual scale.

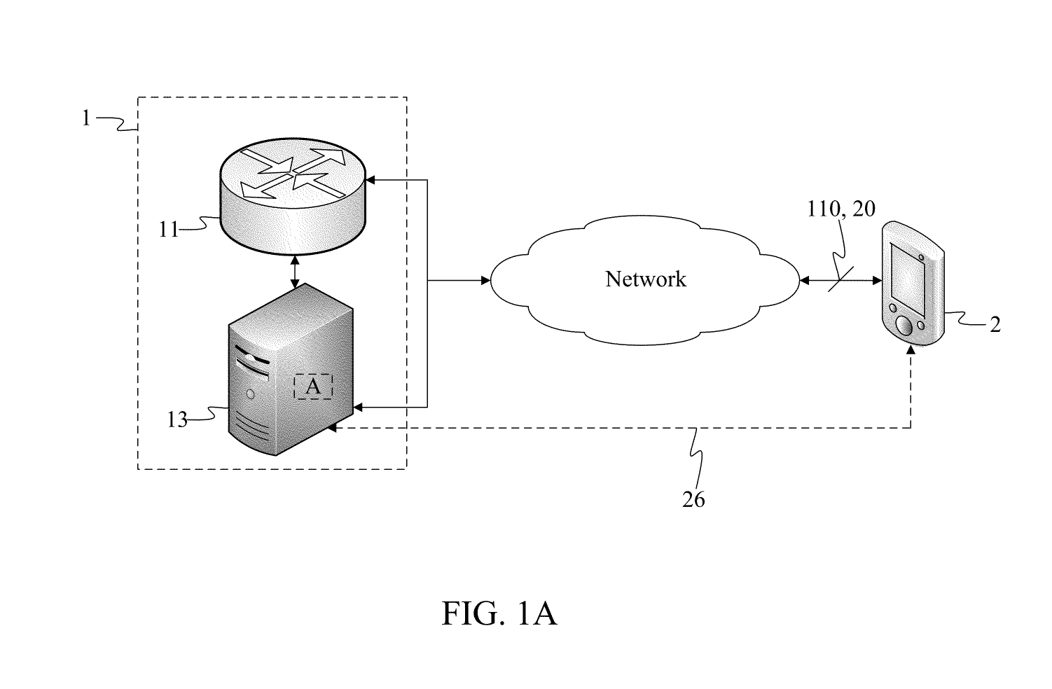

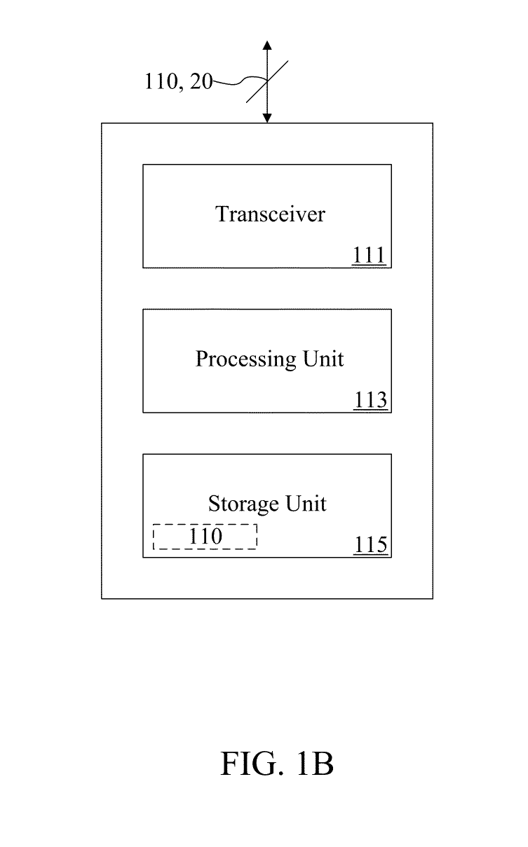

Refer to FIG. 1A and FIG. 1B. FIG. 1A is a schematic view of a network environment of an application management network device 11 according to a first embodiment of the present invention. The application management network device 11 is used in a cloud computing system 1. The cloud computing system 1 further comprises at least one application server. In the first embodiment, the at least one application server includes only an application server 13. A virtual desktop infrastructure (VDI) user device 2 connects to the cloud computing system 1 via network based on VDI protocol. It should be noted that the VDI protocol should be known by the people in the art; therefore, it will not be further described.

FIG. 1B is a block diagram of the application management network device 11 according to the first embodiment of the present invention. The application management network device 11 comprises a transceiver 111, a processing unit 113 and a storage unit 115. The storage unit 115 stores a license 110 of an application A deployed on the application server 13. Interactions between the network components will be further elucidated hereinbelow.

Firstly, when a user wants to use an application, the user logins cloud computing system 1 though VDI user device 2 via network. Then the user transmits an application request 20 by the VDI user device 2 to the application management network device 11 while the application request 20 is used for requesting usage of the application A deployed on the application server 13. In other words, the transceiver 111 of the application management network device 11 receives the application request 20 from the VDI user device 2.

Next, after checking the available license stored in the storage unit 115, the processing unit 113 of the application management network device 11 distributes the license 110 of the application A to the VDI user device 2 according to the application request 20 via the transceiver 111 so that the VDI user device 2 is capable of using the application A deployed on the application server 13 legally.

More specifically, since the VDI user device 2 receives the license 110 of the application A, the VDI user device 2 is capable of using the application A legally. Accordingly, the VDI user device 2 can establish a VDI application connection 26 with the application server 13 via the VDI protocol and execute the application A on the application server 13 based on the license 110. On the other hand, the processing unit 113 of the application management network device 11 then maintains the VDI application connection 26 via the transceiver 111.

Accordingly, in the cloud computing system 1 described in the first embodiment, when VDI user device 2 needs to use application A deployed on the application server 13, the VDI user device 2 transmits the application request 20 to the application management network device 11 for asking the license of the application A. Then, if there is available license 110 of application A, the application management network device 11 distributes the license 110 to the VDI user device 2 so that the VDI user device 2 is authorized to establish the VDI connection 26 with the application server 13 and execute the application A on the application server 13. Then the application management network device 11 is in charge of maintaining the VDI connection 26.

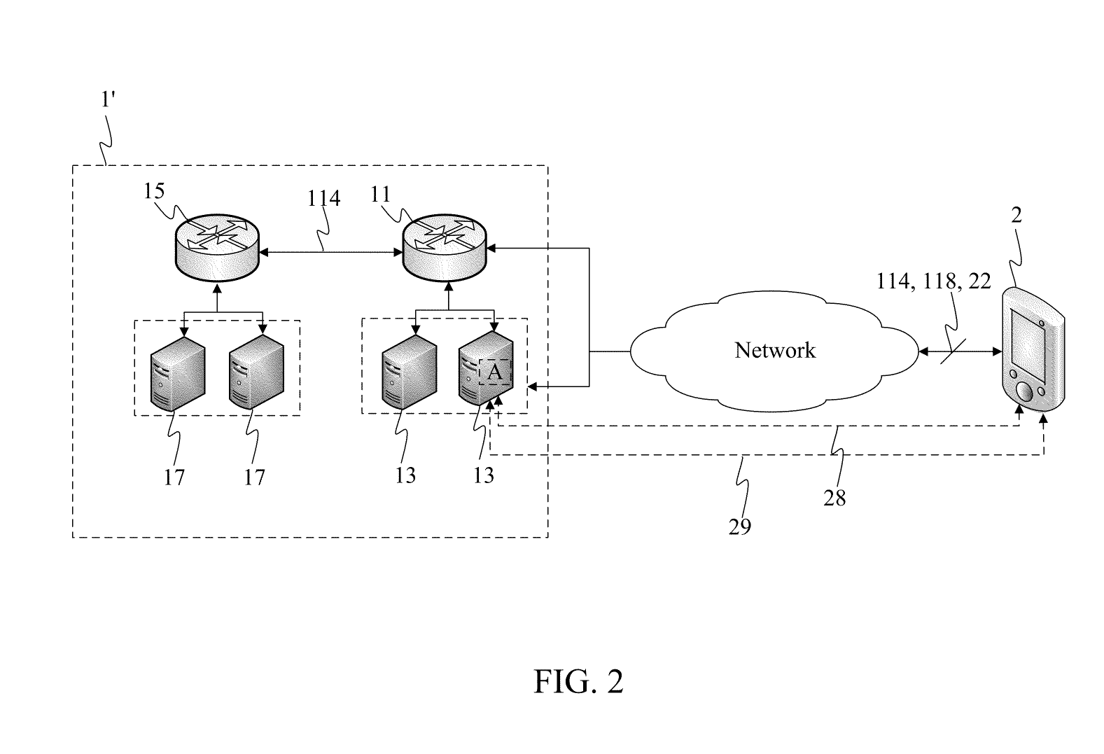

Please refer to FIG. 2. FIG. 2 is a schematic view of another network environment of the application management network device 11 according to a second embodiment of the present invention. It shall be particularly noted that, the network structure of the second embodiment are similar to those of the first embodiment, so components bearing the same reference numerals have the same functions and will not be further described herein.

In the second embodiment, the application management network device 11 is used in a cloud computing system 1′. The cloud computing system 1′ further comprises another application management network device 15 and two application servers 17. The at least one application server includes two application servers 13. The VDI user device 2 connects to the cloud computing system 1′ via network based on VDI protocol as well.

In the second embodiment, before receiving any information from the VDI user device 2, the application management network device 11 informs the VDI user device 2 of the available application. Particularly, the transceiver 111 of the application management network device 11 firstly connects with the VDI user device 2. Then, the processing unit 113 of the application management network device 11 determines an available application list 118 for the VDI user device 2.

It should be noted that, based on the disclosure of the present invention, the people in the art can understand easily that the available application list can be determined based on the identification of the VDI user device (ex., the purchased licenses of the applications by the specific VDI user device) and the applications deployed on the application servers of the could computing system 1′.

Afterward, the transceiver 111 of the application management network device 11 transmits the available application list 118 to the VDI user device 2. Accordingly, the VDI user device 2 is capable of selecting the usable applications from the available application list 118, and executes the application directly on the application server.

Similarly, the user then transmits an application request 22 by the VDI user device 2 to the application management network device 11 while the application request 22 is used for requesting usage of the application A deployed on the application server 13. In other words, the transceiver 111 of the application management network device 11 receives the application request 22 from the VDI user device 2.

Next, after checking the available license stored in the storage unit 115, the processing unit 113 of the application management network device 11 distributes a license 112 of the application A to the VDI user device 2 according to the application request 22 via the transceiver 111 so that the VDI user device 2 is capable of using the application A deployed on the application server 13 legally. Further, since the license 112 is occupied by the VDI user device 2, the processing unit 113 of the application management network device 11 records the license 112 as an unavailable status in the storage unit 115 for preventing the overused of the application A.

Then, the VDI user device 2 establishes a VDI application connection 28 with the application server 13 via the VDI protocol and executes the application A on the application server 13 based on the license 112. On the other hand, the processing unit 113 of the application management network device 11 then maintains the VDI application connection 28 via the transceiver 111.

Furthermore, if the VDI user device 2 fails the VDI application connection 28 with the application server 13, the application management network device 11 should recall the licenses. Specifically, when the VDI application connection 28 is disconnected (ex., the VDI user device 2 logout, the network crashed), the processing unit 113 of the application management network device 11 is capable of determining that the VDI application connection 28 is disabled.

Accordingly, the processing unit 113 of the application management network device 11 recalls the license 112 of the application A since the license 112 is no longer used by the VDI user device 2. And the processing unit 113 of the application management network device 11 records the license 112 as an available status in the storage unit 115 so that the license 112 can be issued again later.

It should be noted that, in the second embodiment, if there is not enough license of application A in the storage unit 115, the application management network device 11 can retrieve possible license of the application A from other application management network devices if the VDI user device 2 had the authorization of accessing other application management network devices.

Specifically, after receiving the application request 22 from the VDI user device 2, the application management network device 11 checks if there is any available license of application A stored in the storage unit 115. If there is not, the processing unit 113 of the application management network device 11 retrieves a license 114 of application A from another application management network device 15 via the transceiver 111.

And then the transceiver 111 distributes the license 114 of application A to the VDI user device 2 accordingly so that the VDI user device 2 establishes a VDI application connection 29 with the application server 13 via the VDI protocol and executes the application A on the application server 13 based on the license 114.

Similarly, if the VDI user device 2 fails the VDI application connection 29 with the application server 13, the application management network device 11 should recall the licenses. Specifically, when the VDI application connection 29 is disconnected, the processing unit 113 of the application management network device 11 is capable of determining that the VDI application connection 29 is disabled.

Accordingly, the processing unit 113 of the application management network device 11 recalls the license 114 of the application A since the license 112 is no longer used by the VDI user device 2. And the processing unit 113 of the application management network device 11 returns the license 114 to another application management network device 15.

In the cloud computing system 1′ described in the second embodiment, when VDI user device 2 can select the application from the available application list 118 transmitted from the application management network device 11, the status of the license 112 can be recorded in the storage unit 115, and the license 114 of application A can be retrieved from another application management network device 15.

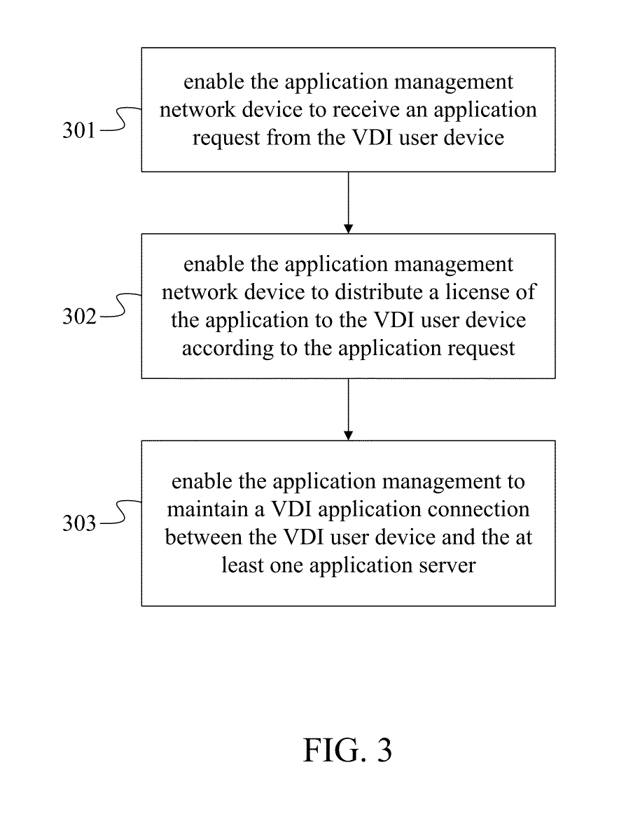

Referring to FIG. 3, there is shown a flowchart diagram of an application management method according to a third embodiment of the present invention. The application management method of the third embodiment is for use in an application management network device (e.g., the application management network device of the first embodiment). The application management network device is used in a cloud computing system. The cloud computing system further comprises at least one application server.

Steps of the application management method of the third embodiment will be detailed as follows. First, step 301 is executed to enable the application management network device to receive an application request from the VDI user device. The application request is used for requesting usage of an application deployed on the at least one application server.

Then, step 302 is executed to enable the application management network device to distribute a license of the application to the VDI user device according to the application request. Finally, step 303 is executed to enable the application management network device to maintain a VDI application connection between the VDI user device and the at least one application server after the VDI user device executes the application deployed on the at least one application server based on the license.

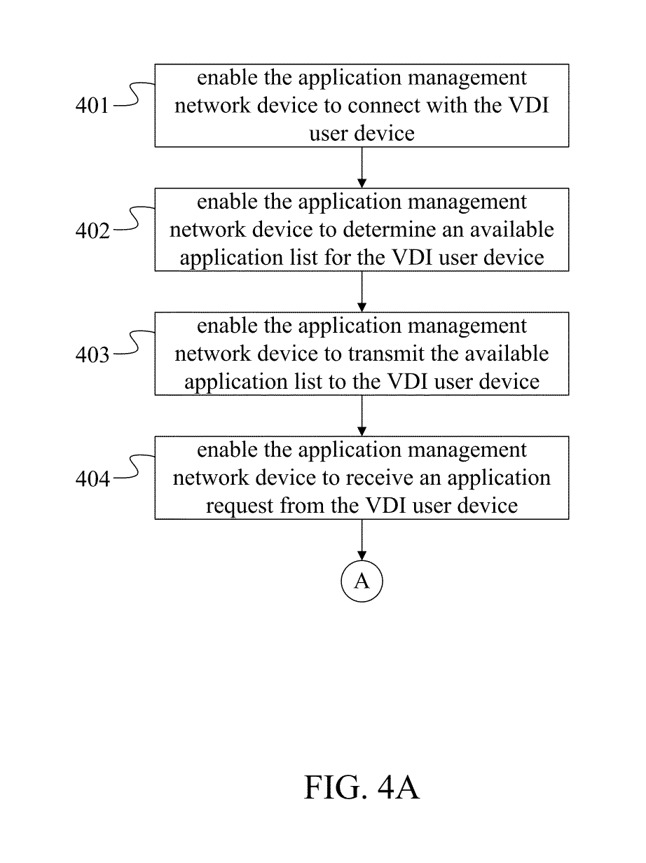

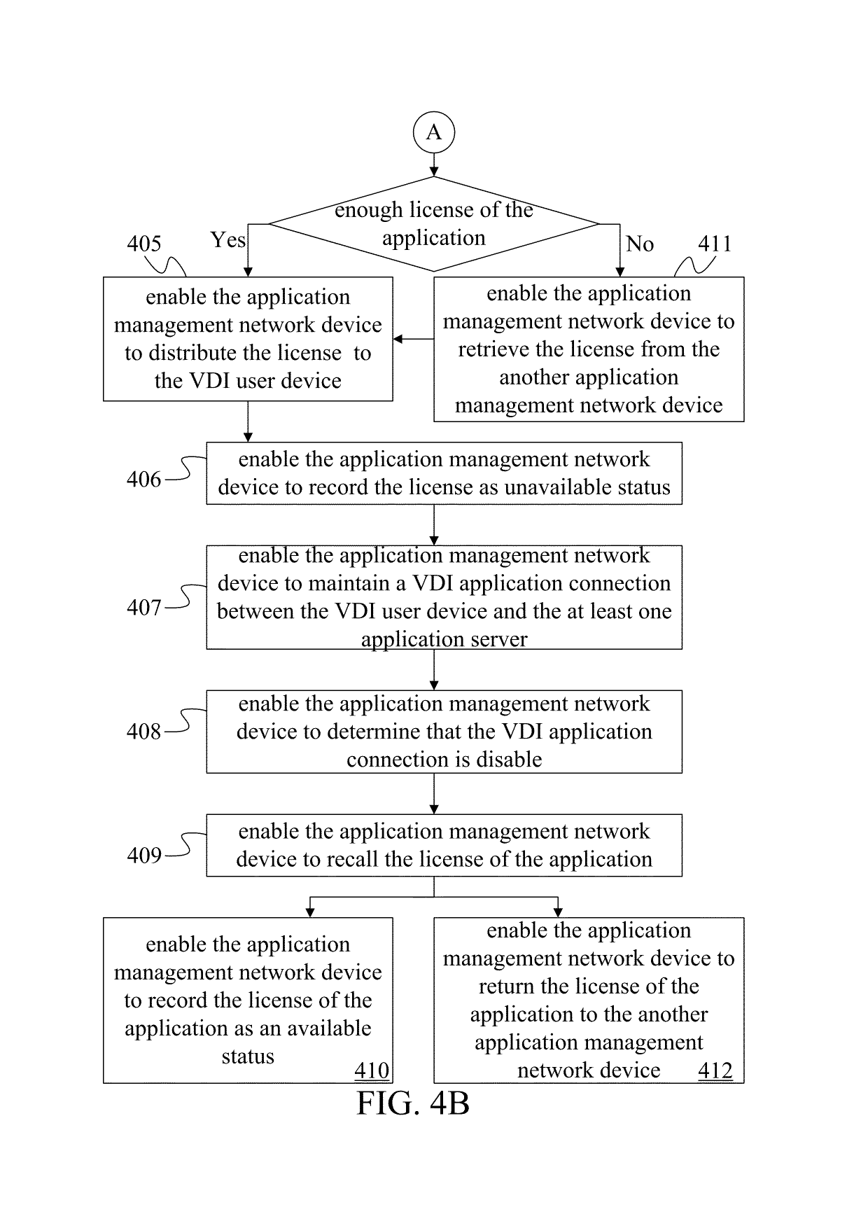

Referring to FIG. 4, there is shown a flowchart diagram of an application management method according to a fourth embodiment of the present invention. The application management method of the fourth embodiment is for use in an application management network device (e.g., the application management network device of the second embodiment). The application management network device is used in a cloud computing system. The cloud computing system further comprises at least one application server and another application management network device.

Steps of the application management method of the fourth embodiment will be detailed as follows. Step 401 is executed to enable the application management network device to connect with the VDI user device. Step 402 is executed to enable the application management network device to determine an available application list for the VDI user device. Step 403 is executed to enable the application management network device to transmit the available application list to the VDI user device so that the VDI user device is capable of selecting the application from the available application list.

Next, step 404 is executed to enable the application management network device to receive an application request from the VDI user device. The application request is used for requesting usage of an application deployed on the at least one application server. Then, if there is enough license of the application in the application management network device, step 405 is executed to enable the application management network device to distribute a license of the application to the VDI user device according to the application request.

Afterwards, step 406 is executed to enable the application management network device to record the license of the application as an unavailable status. Step 407 is executed to enable the application management network device to maintain a VDI application connection between the VDI user device and the at least one application server after the VDI user device executes the application deployed on the at least one application server based on the license.

Step 408 is executed to enable the application management network device to determine that the VDI application connection is disabled. Step 409 is then executed to enable the application management network device to recall the license of the application. Step 410 is executed to enable the application management network device to record the license of the application as an available status.

On the other hand, if there is not enough license of the application in the application management network device, step 411 is firstly executed to enable the application management network device to retrieve the license of the application from the another application management network device, and step 412 is executed to enable the application management network device to return the license of the application to the another application management network device after step 409.

According to the above descriptions of the application management network device and the application management method thereof of the present invention, the user can purchase the license of the applications and execute them directly on the could computing system without downloading. Accordingly, the defects existed in the prior art can be solved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An application management method for use in an application management network device, the application management network device being used in a cloud computing system, the cloud computing system comprising the application management network device and at least one application server, a virtual desktop infrastructure (VDI) user device connecting to the cloud computing system via network, the application management method comprising:
(a) enabling the application management network device to receive an application request from the VDI user device, wherein the application request is used for requesting usage of an application deployed on the at least one application server;
(b) enabling the application management network device to distribute a license of the application to the VDI user device according to the application request;
(c) enabling the application management network device to maintain a VDI application connection between the VDI user device and the at least one application server after the VDI user device executes the application deployed on the at least one application server based on the license.

2. The application management method as claimed in claim 1, further comprising the following steps before step (a):
(a1) enabling the application management network device to connect with the VDI user device;
(a2) enabling the application management network device to determine an available application list for the VDI user device;
(a3) enabling the application management network device to transmit the available application list to the VDI user device so that the VDI user device is capable of selecting the application from the available application list.

3. The application management method as claimed in claim 1, further comprising the following step after step (b):
(b1) enabling the application management network device to record the license of the application as an unavailable status.

4. The application management method as claimed in claim 3, further comprising the following step after steps (c):
(d) enabling the application management network device to determine that the VDI application connection is disabled;
(e) enabling the application management network device to recall the license of the application after step (d);
(f) enabling the application management network device to record the license of the application as an available status after step (e).

5. The application management method as claimed in claim 1, wherein the cloud computing system further comprises another application management network device, and the application management method further comprises the following step before step (b):
(b1) enabling the application management network device to retrieve the license of the application from the another application management network device.

6. The application management method as claimed in claim 5, further comprising the following step after steps (c):
(d) enabling the application management network device to determine that the VDI application connection is disabled;
(e) enabling the application management network device to recall the license of the application after step (d);
(f) enabling the application management network device to return the license of the application to the another application management network device after step (e).

7. An application management network device for used in a cloud computing system, the cloud computing system comprising the application management network device and at least one application server, a virtual desktop infrastructure (VDI) user device connecting to the cloud computing system via network, the application management network device comprising:
a storage unit, being configured to store a license of an application deployed on the at least one application server;
a transceiver, being configured to receive an application request from the VDI user device, wherein the application request is used for requesting usage of the application deployed on the at least one application server;
a processing unit, being configured to distribute the license of the application to the VDI user device according to the application request via the transceiver, and to maintain a VDI application connection between the VDI user device and the at least one application server via the transceiver after the VDI user device executes the application deployed on the at least one application server based on the license.

8. The application management network device as claimed in claim 7, wherein the transceiver is further configured to connect with the VDI user device, the processing unit is further configured to determine an available application list for the VDI user device, and the transceiver is further configured to transmit the available application list to the VDI user device so that the VDI user device is capable of selecting the application from the available application list.

9. The application management network device as claimed in claim 7, wherein the processing unit is further configured to record the license of the application as an unavailable status in the storage unit.

10. The application management network device as claimed in claim 9, wherein the processing unit is further configured to determine that the VDI application connection is disabled, to recall the license of the application, and to record the license of the application as an available status in the storage unit.

11. The application management network device as claimed in claim 7, wherein the cloud computing system further comprises another application management network device, the processing unit is further configured to retrieve the license of the application from the another application management network device via the transceiver.

12. The application management network device as claimed in claim 11, wherein the processing unit is further configured to determine that the VDI application connection is disabled, to recall the license of the application, and to return the license of the application to the another application management network device via the transceiver.
